(19) United States
(12) Patent Application Publication
(10) Pub. No.: US 2005/0274822 A1
(43) Pub. Date: Dec. 15, 2005

(54) Spray system with chemical injector and water supply line

(76) Inventor: Robert Lyons, Annandale, NJ (US)

Correspondence Address: CALFEE HALTER & GRISWOLD, LLP, 800 SUPERIOR AVENUE, SUITE 1400, CLEVELAND, OH, 44114, US

(21) Appl. No.: 10/993,463

(22) Filed: Nov. 19, 2004

Related U.S. Application Data
(60) Provisional application No. 60/523,912, filed on Nov. 21, 2003.

(51) Int. Cl. A62C 5/02

(52) U.S. Cl. 239/310; 239/413

(57) ABSTRACT

A spray system for spraying two liquids, such as either water only or a water and chemical mixture, includes an outlet nozzle supplied by a twin line conduit. A first one of the lines is a flow through line for delivering unmixed water. A second one of the lines is connected with a venturi for drawing a chemical from a container to mix the chemical with water flowing through the second line.

### BACKGROUND OF THE INVENTION

1. Technical Field

The present invention relates to a spray system and, in particular, to a system for spraying two different liquids, such as water mixed with a chemical.

2. Description of the Prior Art

Spray systems that spray two different liquids, such as water mixed with a chemical are known. As one example, a typical hose end sprayer attaches to the outlet end of a garden hose. The sprayer has a container that holds one to two quarts of a chemical. As water flows through the hose and the sprayer, a venturi effect causes the chemical to be drawn from the container and mixed with the water being sprayed from the hose. This output can be used to, for example, clean an item such as a house, or to chemically treat a lawn.

One drawback to a hose end sprayer is that it is not practical for use in dispensing large amounts of materials, because the amount of chemical available for dispensing is directly dependent on the size of the product container, which is limited to the weight that an operator can practically hold and manipulate on a hose end.

Another type of spray system connects a garden hose to a venturi injector that draws material from a stationary container. The chemical is mixed with the water in the injector and is dispensed downstream through a single line and a nozzle. This type of system can enable the use of larger containers of chemicals, but does not provide the operator with the option of delivering clean water only. The operator applies either the chemical mixed with water or nothing at all.

### SUMMARY OF THE INVENTION

In one aspect the invention relates to a spray system for spraying two different liquids, such as either water only or a water and chemical mixture. The system includes an outlet nozzle supplied by a twin line delivery conduit, a first one of the lines being a flow through line for delivering unmixed water, a second one of the lines being connected with a venturi for drawing chemical material from a container to mix the chemical material with water flowing through the second line.

### BRIEF DESCRIPTION OF THE DRAWINGS

FIG. 1 is a schematic illustration of a spray system that is one embodiment of the invention;

FIG. 2 is an enlarged schematic illustration of an inlet and venturi portion of the spray system of FIG. 1;

FIG. 3 is an enlarged schematic illustration of an outlet portion of the spray system of FIG. 1; and

FIG. 4 is a schematic sectional view through the outlet portion of FIG. 3.

### DETAILED DESCRIPTION OF THE INVENTION

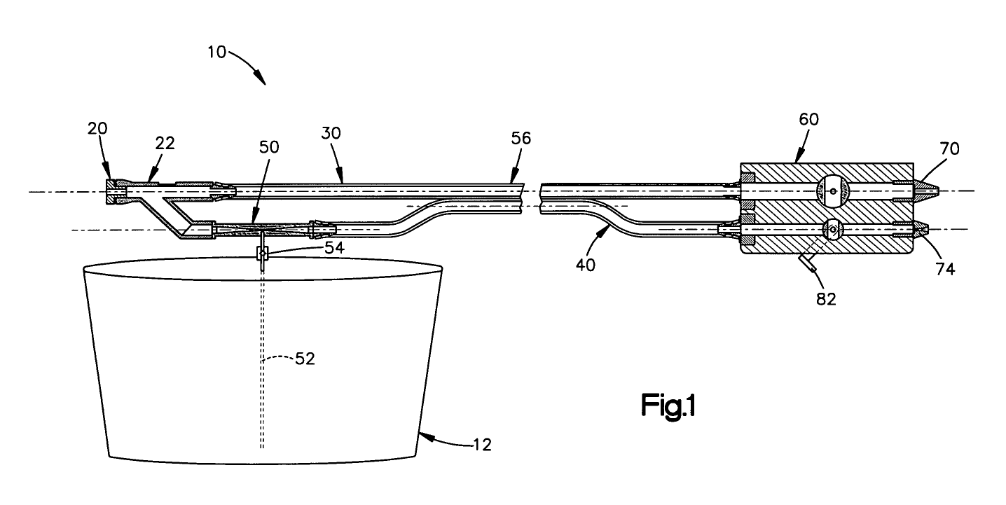

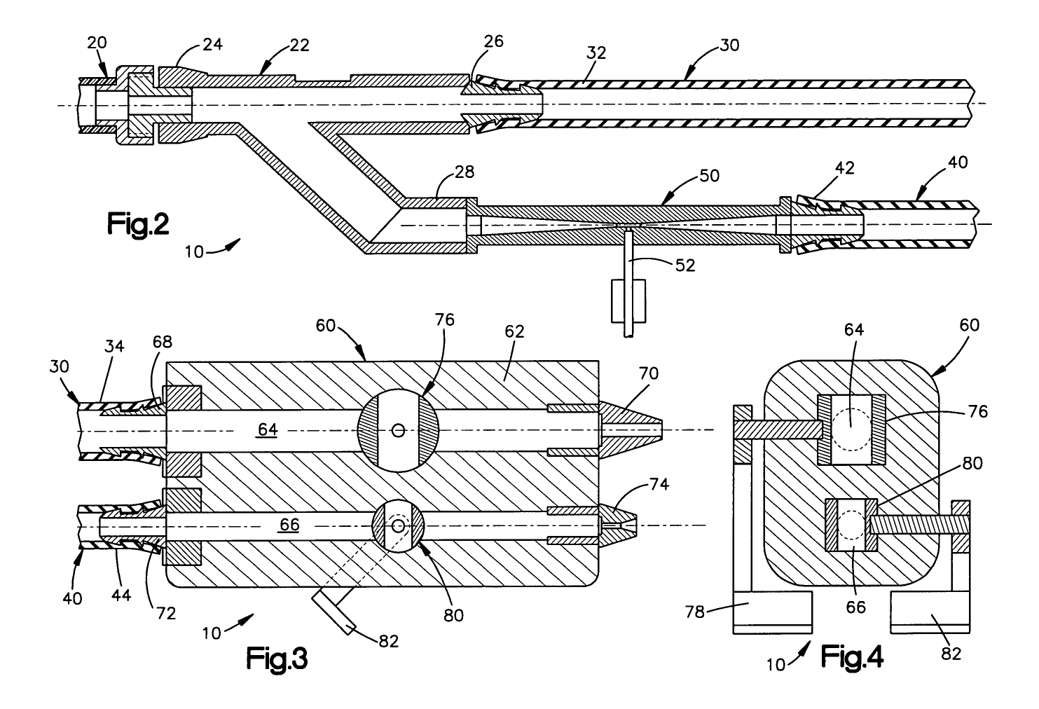

The present invention relates to a spray system and, in particular, to a system for spraying two different liquids, such as water mixed with an injected chemical. The invention is applicable to spray systems of varying different constructions. The invention may be used with systems for spraying for different purposes, such as cleaning a house or car or another structure or machine, for treating a lawn, for spraying pesticide or insecticide, etc. As representative of the invention, FIG. 1 illustrates a spray system 10 that is a first embodiment of the invention. The system 10 is adapted for spraying water mixed with a chemical from a container 12.

The system 10 is adapted for use with a water source indicated schematically at 20. The water source 20 may be, for example, the male end of a garden hose. Other water sources 20 are suitable.

The system 10 includes a connector 22 for connection with the water source 20. Various different types of connectors 22 are suitable, including connectors that connect two lines separately to the water source 20 and connectors that connect both lines. The connector 22 adapts also to the particular water source 20 that is used. Tej water source could be a water line, or a hose, or a spigot attached to the plumbing of a house or other structure.

In the illustrated embodiment, the connector 22 is a Y connector having an inlet 24 for connection with the water source 20. The Y connector 22 has a first outlet 26 and a second outlet 28, both of which are in fluid communication with the connector inlet 24.

The system 10 includes a first water line or first line 30 and a second water line or second line 40. The first line 30 is preferably a length of hose or tubing that has an upstream end portion 32 connected with the first outlet 26 of the connector 22. The first line 30 has a downstream end portion 34. The inner diameter of the first line 30 is selected to provide a relatively large flow of water, sufficient for cleaning or rinsing by spraying without chemical addition. In one embodiment, the inner diameter of the first line 30 may be 5/8 inches, for example, if the system 10 is connected to a water source that includes a garden hose or house supply.

The second line 40 is preferably a length of hose or tubing that has an upstream end portion 42 that is connected with the second outlet 28 of the connector 22. The second line 40 has a downstream end portion 44. The inner diameter of the second line 40 is preferably, although not necessarily, selected to provide a flow of water that is less than the flow in line 30, for providing water mixed with chemical. In one embodiment, the inner diameter of the second line 40 may be 3/8 inches, for example, if the system 10 is connected to a water source that includes a garden hose or house supply.

The system 10 includes structure for delivering chemicals from the container 12 into the second water line 40. In the illustrated embodiment, the mechanism is a venturi injector 50. Other types of injectors and mechanisms are possible.

The ability to deliver chemical requires maintaining an adequate pressure differential between the inlet and outlet sides of the chemical injector. This can be accomplished with many different combinations of venturis, flow nozzles, or orifice plates. Therefore, the venturi injector 50 is preferably one that will operate well on the water pressure found at the water source 20. In the illustrated embodiment, the venturi injector 50 is preferably one that will operate well on the 25-75 pounds of water pressure typically found in a home plumbing system.

The venturi injector 50 used matches the available rate of flow and water pressure. One configuration assumes 40 psi of water pressure with a maximum flow rate of 3 gallons per minute. One system that has proven to be particularly efficient with inlet pressures between 40 psi and 60 psi is the combination of a Mazzei brand injector #283 and an outlet nozzle with a 0.072″ orifice.

A chemical inlet 52 extends between the injector 50 and the container 12. The inlet connects 52 the injector 50 in fluid communication with the container 12, for drawing chemicals from the container to the injector and thereby to the second line 40. The chemical inlet 52 may be, for example, a suction tube. A ball check valve or other type of check valve as shown at 54 is preferably provided in the suction line 52 to prevent flow of water into the container 12.

A pressurized fluid source could be substituted for the venturi injector 50. This source could be a pressurized vessel of a pressure pump fitted with a pressure regulator and metering valve, that would inject concentrate into the second line. Such a system would maintain the benefit of having two materials lines in the hands of the operator.

The first line 30 is preferably joined to the second line 40 from a point just downstream of the venturi injector 50 to a point just upstream of the nozzle 60. The two lines 30 and 40 may be joined in various manners, for example by co-extrusion or with ties or clips or in other manners. This joining may take place for as much as possible of the length of the lines 30 and 40, for example, from the venturi 50 to the nozzle 60. This configuration provides a single manually graspable line assembly 56 for use by the operator, rather than two separately movable lines. As other alternatives, the venturi or other chemical supply could be connected at the nozzle 60; the and the two fluid lines could be joined or separated at different locations in the system, not limited to those shown and described.

The system 10 includes a nozzle 60, that is, a structure for dispensing the outputs of the first and second lines 30 and 40. In the illustrated embodiment, the nozzle 60 is a twin port nozzle, that is, a single unit that controls fluid flow out of both lines 30 and 40. Other types of nozzles are suitable, including nozzles that are or that have two separate units for the two lines 30 and 40.

The illustrated nozzle 60 has a body 62 that defines first and second fluid passages 64 and 66. A first inlet connector 68 and a first spray tip 70 on the body 62 are in fluid communication with the first fluid passage 64. A second inlet connector 72 and a second spray tip 74 on the body 62 are in fluid communication with the second fluid passage 66. The second inlet connector 72 may be a different size from the first inlet connector 68, to match with different size tubing of the first and second water lines 30 and 40.

A first valve 76 controls fluid flow through the first passage 64. The first valve 76 may be a ball valve, as shown, or may be another type of valve or control device. The first valve 76 is manually actuatable by a first handle 78.

A second valve 80 controls fluid flow through the second passage 66. The second valve 80 may be a ball valve, as shown, or may be another type of valve or control device. The second valve 80 is manually actuatable by a second handle 82.

In operation of the system 10, the container 12 is placed in an appropriate position relative to the water source 20 and to the object or surface to be sprayed. The suction line 52 is connected between the venturi injector 50 and the container 12. The venturi injector 50 is connected in the second line 40. The first and second lines 30 and 40 are connected to the water source 20 by the connector 22.

When the water is turned on, flow through the first and second lines 30 and 40 is controlled by the first and second valves 76 and 80, respectively. Thus, if the operator first desires clear water only, the operator opens the first valve 76 the desired amount and closes the second valve 80. This prevents flow through the second line 40.

When the operator wants to provide chemical spraying, the operator opens the second valve 80 the desired amount. Water flows through the second line 40 and through the venturi 50. Chemical is drawn from the container 12 through the suction line 52 and mixes with the water in the second line 40.

The amount of chemical being sprayed can be controlled by controlling the volume of water flowing through the second line 40. The overall amount of water being sprayed can be controlled by controlling the amount of water flowing through the first and second lines 30 and 40.

Some of the advantages that may be obtained with embodiments of the invention are as follows. A large amount of chemical can be delivered without stopping the spraying process, because of the ability to use a large stationary container connected with the second line 40. The operator does not need to hold a large or heavy container. As a result, down time resulting from the need to change containers is reduced. Also, most hose end sprayers are disposable or throw away containers, and so waste is reduced.

The first line 30 alone, can provide a constant stream of water, undiluted with chemical if desired, and at a large flow rate. This allows the operator to deliver a maximum amount of water volume and pressure to the surface or object being cleaned. This result would not be possible if there were only one line, with the venturi in the single line, because a significant loss of pressure and volume occurs when water passes through a venturi. In addition, the first (undiluted) line 30 can be larger in flow area than the other (chemical) line 40, further increasing the motive flow available at the nozzle 60, for cleaning and rinsing, for example.

1. A spray system for spraying two different liquids, comprising a nozzle and a conduit connected to the nozzle, the conduit comprising a first line delivering a first liquid and a second line that is also connected to a chemical supply mechanism for providing a chemical from a container to create a second liquid, said second line delivering the second liquid to the nozzle, whereby said nozzle may spray either the first liquid or the second liquid or both the first and second liquids.

2. A system as set forth in claim 1 wherein the first liquid is water and the nozzle may spray either water or water mixed with the chemical.

3. A system as set forth in claim 1 wherein the chemical supply is a venturi injector for drawings the chemical from the container.

3a. A system as set forth in claim 3 further including a suction line connecting the venturi injector with the container and a check valve in the suction line.

4. A system as set forth in claim 1 wherein the nozzle includes first and second spray tips for separately spraying the output of the first and second lines.

5. A system as set forth in claim 1 wherein the nozzle includes first and second valves for separately controlling the output of the first and second lines.

6. A system as set forth in claim 1 wherein the nozzle includes first and second valves for separately controlling the output of the first and second lines.

7. A system as set forth in claim 1 further comprising a two-outlet connector for connection with a water source and with the first and second lines.

8. A spray system for spraying a chemical mixed with water from a water source, said system comprising:
a first water line having an upstream end portion for connection with the water source and having a downstream end portion;
a second water line having an upstream end portion for connection with the water source and having a downstream end portion;
a venturi injector in the second water line between the upstream end portion and the downstream end portion of the second water line;
a chemical inlet for delivering chemical material from a chemical container into the venturi injector and thereby into the second water line; and
a nozzle connected with the downstream end portion of the first water line and with the downstream end portion of the second water line, for dispensing the contents of the first and second water lines.

9. A system as set forth in claim 8 further including a check valve for preventing flow of water into the container through the chemical inlet.

10. A system as set forth in claim 8 wherein the nozzle includes a single body with two fluid passages for delivering fluid from the first and second water lines, respectively.

11. A system as set forth in claim 10 wherein the nozzle has first and second valves for controlling independently flow out of the first and second water lines.

12. A system as set forth in claim 11 wherein the valves are on-off ball valves.

13. A system as set forth in claim 8 wherein the first water line and the second water line are joined together between the venturi injector and the nozzle.

14. A system as set forth in claim 8 including a suction tube and a check valve in the suction tube for preventing flow of water into the container.

15. A system as set forth in claim 8 wherein the flow area of the first water line is larger than the flow area of the second water line.

16. A system as set forth in claim 8 wherein the flow area of the first water line is about ⅝″ and the flow area of the second water line is about ⅜″.

17. A system as set forth in claim 8 further comprising a two-outlet connector for connection with a water source.

18. A spray system for spraying a chemical from a container as mixed with water from a water source, said system comprising:
a first water line having an upstream end portion for connection with the water source and having a downstream end portion;
a second water line having an upstream end portion for connection with the water source and having a downstream end portion;
a venturi injector in the second water line between the upstream end portion and the downstream end portion of the second water line for delivering chemical material from a chemical container into the second water line; and
a nozzle connected with the downstream end portion of the first water line and with the downstream end portion of the second water line, for dispensing the contents of the first and second water lines, the nozzle including has a single body with two fluid passages for delivering fluid from the first and second water lines, respectively, the nozzle having first and second valves for controlling independently flow out of the first and second water lines;
the first water line and the second water line being joined together for a substantial portion of their length between the venturi injector and the nozzle.

19. A system as set forth in claim 18 further including a suction tube connected with the venturi injector for drawing chemical material from the container, and a check valve in the suction tube for preventing flow of water into the container.

20. A system as set forth in claim 18 wherein the first water line is larger in diameter than the second water line.

21. A system as set forth in claim 18 further comprising a two-outlet connector for connection between the water source and the first and second water lines.

22. A spray system for spraying a chemical mixed with water, said system comprising:
connector means for connection with a water source;
first and second water line means for connection with the connector means and for delivering water from the water source;
chemical supply means connected with the second water line means for delivering chemical material from a chemical container into the second water line means; and
nozzle means connected with the first and second water line means for dispensing the contents of the first and second water line means.

23. A system as set forth in claim 22 including means for joining the first and second water line together for a substantial portion of their length between the chemical supply means and the nozzle means.

24. A system as set forth in claim 22 wherein the chemical supply means is a venturi injector.
